(19) United States
(12) Patent Application Publication
(10) Pub. No.: US 2018/0330331 A1
(43) Pub. Date: Nov. 15, 2018

(54) PROCESSING RELATIONALLY MAPPED DATA TO GENERATE CONTEXTUAL RECOMMENDATIONS

(71) Applicant: Accenture Global Solutions Limited, Dublin (IE)

(72) Inventors: Anup Nair, Bangalore (IN); Tanushree Guha, Kolkata (IN)

(21) Appl. No.: 15/960,090

(22) Filed: Apr. 23, 2018

(30) Foreign Application Priority Data
May 10, 2017 (IN) 201741016430

(51) Int. Cl. G06Q 10/10; G06F 17/30

(52) U.S. Cl. CPC G06Q 10/1053; G06F 17/30554; G06F 17/30867; G06F 17/30569

(57) ABSTRACT

A device may receive data regarding a set of entities. The device may pre-process the data regarding the set of entities to convert a portion of the data from an unstructured format to a structured format. The device may generate a network representation of the data. The network representation may include a plurality of nodes representing characteristics of the data and a plurality of edges connecting at least some of the plurality of nodes and representing a relationship between each pair of connected nodes of the plurality of nodes. The device may automatically evaluate the network representation of the data to determine a set of recommendations relating to the set of entities. The device may generate a user interface to provide information identifying the set of recommendations. The device may communicate with a client device to cause the user interface to be provided for display via the client device.

### RELATED APPLICATION

This application claims priority under 35 U.S.C. § 119 to Indian Patent Application No. 201741016430, filed on May 10, 2017, the content of which is incorporated by reference herein in its entirety.

### BACKGROUND

An entity may be associated with a set of characteristics that may match a set of required characteristics for being classified into a particular group of entities. For example, a job applicant may have a set of skills that may be required for a particular job. The job applicant may view a job posting that may identify one or more requirements for the particular job, such as a particular educational requirement, a particular experience requirement, a particular skill competency (e.g., a skill in computer programming, a skill in application testing, a skill in customer service, etc.), and may determine to apply to a job based on satisfying the one or more requirements. An organization may attempt to identify job candidates by having recruiting managers of the organization view many job applicant profiles to identify one or more job applicants that satisfy requirements for a particular job.

### SUMMARY

According to some possible implementations, a device may include one or more processors. The one or more processors may receive data regarding a set of entities. The one or more processors may pre-process the data regarding the set of entities to convert a portion of the data from an unstructured format to a structured format. The one or more processors may generate, after pre-processing the data, a network representation of the data. The network representation may include a plurality of nodes representing characteristics of the data and a plurality of edges connecting at least some of the plurality of nodes and representing a relationship between each pair of connected nodes of the plurality of nodes. The one or more processors may automatically evaluate the network representation of the data to determine a set of recommendations relating to the set of entities. The one or more processors may generate a user interface to provide information identifying the set of recommendations. The one or more processors may communicate with a client device to cause the user interface to be provided for display via the client device.

According to some possible implementations, a method may include determining, by a device, entity information regarding a set of entities. The set of entities may include at least one of a set of potential job applicants to an organization or a set of employees of the organization. The method may include generating, by the device, a skill network representing a set of first order relationships and a set of higher order relationships between pairs of skills of a set of skills. The method may include determining, by the device, a role recommendation for one or more entities of the set of entities. The role recommendation may identify a recommended role for the one or more entities. The recommended role may be a new role or a change to a role for the one or more entities. The method may include performing, by the device, a response action based on the role recommendation.

According to some possible implementations, a non-transitory computer-readable medium may store one or more instructions that, when executed by one or more processors, cause the one or more processors to obtain entity information regarding a set of entities from a set of data sources. The set of entities may include at least one of a set of potential job applicants to an organization or a set of employees of the organization. The one or more instructions, when executed by the one or more processors, may cause the one or more processors to generate a skill network representing a set of first order relationships and a set of higher order relationships between pairs of skills of a set of skills. The skill network may include a set of nodes representing the set of skills and a set of edges representing the first order relationships between skills of the set of skills. The one or more instructions, when executed by the one or more processors, may cause the one or more processors to determine a role recommendation. The role recommendation may identify a role for an entity of the set of entities. The entity may be associated with a first subset of skills. The role may be associated with a second subset of skills including at least one skill not included in the first subset of skills. The at least one skill may have a threshold similarity to a corresponding at least one skill of the first subset of skills. The one or more instructions, when executed by the one or more processors, may cause the one or more processors to provide information associated with identifying the role recommendation.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for determining a role recommendation using a skill network.

### DETAILED DESCRIPTION

The following detailed description of example implementations refers to the accompanying drawings. The same reference numbers in different drawings may identify the same or similar elements.

An organization may employee hundreds, thousands, or even millions of employees to perform tasks for the organization. For example, a software development organization may employ developers, testers, customer service representatives, managers, human resources personnel, executives, analysts, lawyers, accountants, food service workers, janitorial staff, or the like. A task may be associated with a set of skills that enable the task to be completed. For example, development of a web application may require a skill in a particular programming language used for web development. However, some tasks may be associated with dozens, hundreds, or even thousands of interconnected skills that enable the task to be completed effectively. For example, an effective code tester may possess skills in programming (e.g., to understand code), testing (e.g., to test code), mathematics (e.g., to optimize algorithms), subject matter (e.g., to understand a subject purpose of the code, such as operating a communications network), customer service (e.g., to manage customer complaints about the code), communication (e.g., to coordinate with customers, team members, and managers), report writing (e.g., to document solutions to a code error), leadership (e.g., to manage team members in completing a code testing task), accounting (e.g., to manage time and resources of a team), or the like.

Skill relationships may be characterized using a skill relationship matrix that identifies skills corresponding to tasks. However, as tasks become increasingly complex and organizations track thousands, millions, or even billions of metrics regarding employees and work product, matrix analysis of skills may result in excessive utilization of computing resources and excessive data storage requirements. Moreover, a matrix based analysis may result in a relatively poor analysis of skill relationships, thereby limiting an ability to identify talent for job openings. For example, although a job applicant lacks experience in a first programming language resulting in the job applicant failing to satisfy criteria for a job, the job applicant may have experience in a second, similar programming language that enables the job applicant to effectively complete a task for the job despite lacking experience in the first programming language. Based on failing to identify talented employees for job openings, an organization may produce work product that fails to satisfy a threshold quality level, such as error prone code, which may result in excessive utilization of organization resources (e.g., computing resources, energy resources, time, money, etc.) to revise errors, to complete tasks, or the like.

Some implementations, described herein, provide relational mapping for contextual data relating to skills, organizational tasks, and organizational jobs, thereby enabling improved identification of potential employees, hiring of employees, and management of employees. Based on improving a level of skill of employees of an organization and/or aligning employees to roles utilizing skills of the employees, an organization may reduce resource utilization, such as computing resource utilization to complete tasks (e.g., by less talented employees), energy resources to complete tasks (e.g., resulting from excessive time spent using computers to complete tasks), or the like.

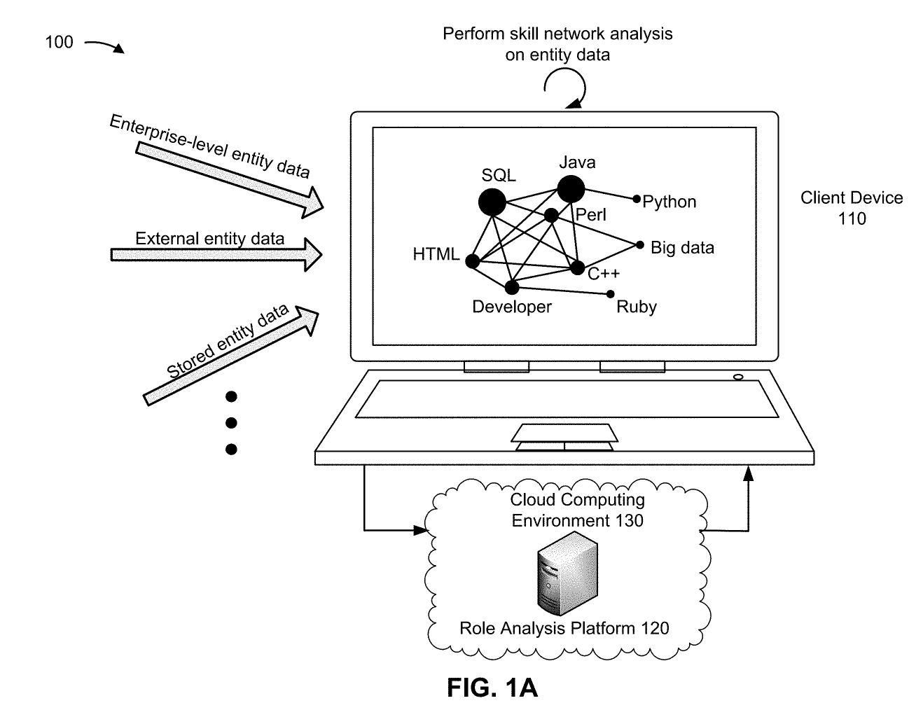

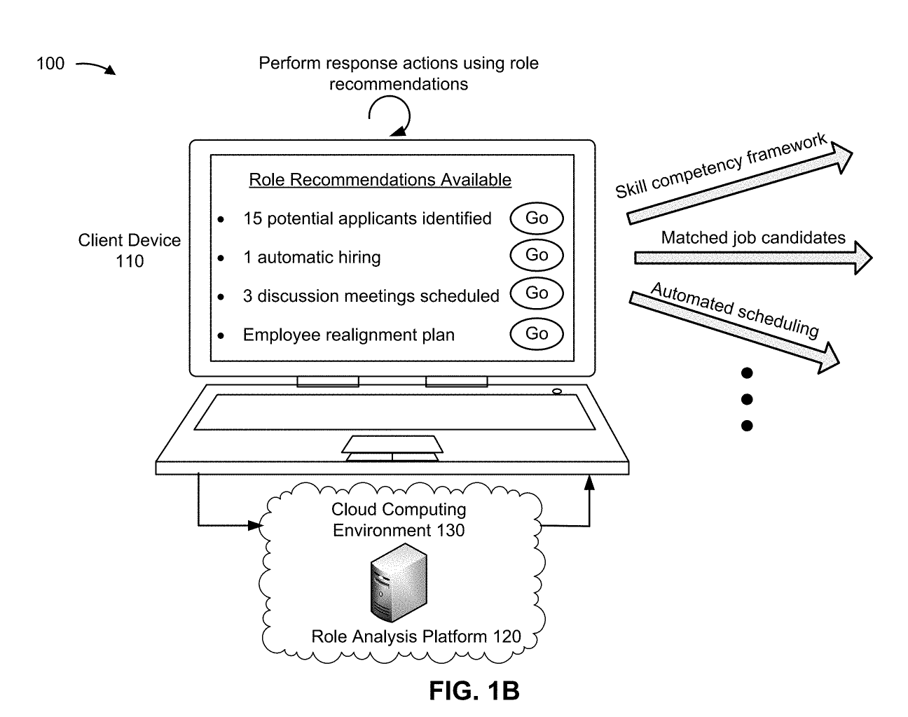

FIGS. 1A and 1B are diagrams of an overview of an example implementation 100 described herein. As shown in FIGS. 1A and 1B, example implementation 100 may include client device 110 and role analysis platform 120, which operates in cloud computing environment 130.

As shown in FIG. 1A, role analysis platform 120 receives entity data from a set of data sources. Entity information may refer to information regarding an entity, such as information regarding an employee of an organization (e.g., an employee record, data regarding tasks completed by an employee, information regarding roles of an employee, etc.), information regarding a potential employee of the organization (e.g., a social media profile of a job applicant, a resume posted to a job placement website, etc.), information regarding employees of other organizations, or the like. For example, role analysis platform 120 may provide a user interface via a set of client devices 110, and may receive information from a set of users of the set of client devices 110 (e.g., employees of an organization) regarding tasks completed by the set of users. Additionally, or alternatively, role analysis platform 120 may obtain, from a data source, enterprise-level data (e.g., data from a set of enterprise data structures of enterprise systems utilized by one or more organizations and regarding employees of the one or more organizations), external entity data (e.g., data from a set of locations, such as websites, of a wide area network, such as the Internet, regarding people not associated with the organization), stored entity data (e.g., data stored by role analysis platform 120 based on a previous analysis of the organization or another organization), or the like.

As further shown in FIG. 1A, role analysis platform 120 may perform a skill network analysis using the entity data. For example, role analysis platform 120 may pre-process the entity data to structure the data; may generate a skill relationship matrix identifying skills associated with a threshold similarity, skills corresponding to particular roles, or the like using a recommendation analysis technique; and may generate a skill network (e.g., a graph network representation of relationships, such as first order relationships and higher order relationships, between pairs of skills) based on the skill relationship matrix. In some implementations, role analysis platform 120 may generate the skill relationship matrix using an item based collaborative filtering technique. For example, role analysis platform 120 may compute a cosine similarity for sets of skills to determine a relationship between sets of skills. In some implementations, role analysis platform 120 may perform the skill network analysis to identify higher order skill relationships. For example, role analysis platform 120 may utilize the skill relationship matrix (e.g., which identifies first order relationships between sets of skills, such as first order relationships of skill A to skill B and of skill B to skill C) to generate a skill network identifying 2^{nd} order relationships, 3^{rd} order relationships, . . . , nth order relationships, etc. between sets of skills (e.g., a second order relationship between skill A to skill C may be associated with the relationship of skill A to skill B and of skill B to skill C).

In some implementations, role analysis platform 120 may generate a set of nodes corresponding to skills for roles at an organization and a set of edges corresponding to first order relationships, second order relationships, etc. between skills, and may provide an identification of the nodes and edges for display via a user interface of client device 110, as shown in FIG. 1A. In some implementations, role analysis platform 120 may apply a shortest path algorithm to the nodes and edges to determine higher order relationships. In some implementations, role analysis platform 120 may identify a set of critical nodes based on the skill network. A critical node may be associated with a threshold cosine similarity to a threshold quantity of other nodes of the skill network. In some implementations, role analysis platform 120 may determine the critical nodes using a critical node problem (CNP) technique to find a subset of nodes which, if deleted, result in a threshold fragmentation of the skill network. Based on the skill network, role analysis platform 120 may determine a set of role recommendations for a set of entities. For example, role analysis platform 120 may determine a recommendation that an employee be switched from a first role to a second role based on skills of the employee. Additionally, or alternatively, role analysis platform 120 may recommend recruitment of a job applicant based on the job applicant being associated with a threshold quantity of skills corresponding to critical nodes.

As shown in FIG. 1B, role analysis platform 120 may perform a set of response actions based on generating the skill network and determining the role recommendations. For example, role analysis platform 120 may provide information identifying a skill competency framework (e.g., an identification of clusters of skills based on skill similarities), a set of messages to a set of job candidates matching a set of skills for a set of roles that are to be filled, a set of scheduling messages to a set of calendar applications for a set of meetings (e.g., a set of employee interviews, a set of employee realignment discussions, etc.), or the like. In some implementations, role analysis platform 120 may generate a user interface, for display via client device 110, that identifies the set of role recommendations. In this case, role analysis platform 120 may provide, via the user interface, information identifying a set of potential job applicants to target for recruitment, a job applicant for hiring, or the like.

In some implementations, role analysis platform 120 may automatically transmit messages to the potential applicants. Based on more accurately targeting job applicants based on the skill network analysis, role analysis platform 120 may enable identification of a threshold quantity of employees with fewer candidates needing to be contacted, thereby reducing network traffic, such as by eliminating hundreds, thousands, or millions of emails sent to potential job applicants, relative to another technique for identifying employees. Additionally, or alternatively, role analysis platform 120 may identify an employee realignment plan associated with reassigning employees of the organization to roles that align more closely with skills of the employees and skills that enable fulfillment of the roles. In this way, role analysis platform 120 may enable improved work product and efficiency by employees, thereby reducing an amount of computing resources expended correcting poor employee work product, an amount of computing resources expended to complete employee work product, or the like relative to another technique for assigning employees to roles at an organization.

In this way, role analysis platform 120 enables efficient, network-based analysis of skills and roles of an organization using thousands, millions, or even billions of data points, thereby enabling more accurate targeting of job applicants, more accurate assignment of tasks to employees, or the like. Based on improving an accuracy of targeting and assignment, some implementations of role analysis platform 120 reduce network traffic, utilization of computing resources, or the like.

As indicated above, FIGS. 1A and 1B are provided merely as an example. Other examples are possible and may differ from what was described with regard to FIGS. 1A and 1B.

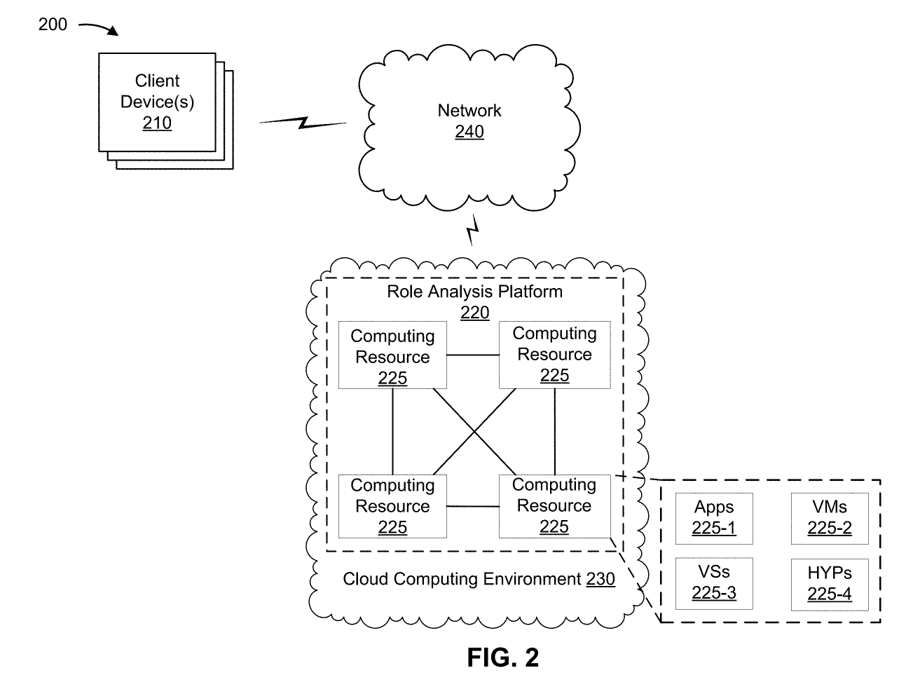

FIG. 2 is a diagram of an example environment 200 in which systems and/or methods, described herein, may be implemented. As shown in FIG. 2, environment 200 may include one or more client device(s) 210, a role analysis platform 220, a cloud computing environment 230, and a network 240. Devices of environment 200 may interconnect via wired connections, wireless connections, or a combination of wired and wireless connections.

Client device 210 includes one or more devices capable of receiving, generating, storing, processing, and/or providing information associated with analyzing skills of entities, such as employees of an organization, groups of employees of an organization, job applicants of an organization, potential job applicants of an organization, employees of other organizations, or the like. For example, client device 210 may include a communication and/or computing device, such as a mobile phone (e.g., a smart phone, a radiotelephone, etc.), a computer (e.g., a desktop computer, a laptop computer, a tablet computer, a handheld computer, etc.), a gaming device, a wearable communication device (e.g., a smart wristwatch, a pair of smart eyeglasses, etc.), or a similar type of device. In some implementations, client device 210 may provide, via a user interface, information associated with a skill network, such as an employee recruitment plan, an employee realignment plan, or the like. In some implementations, client device 210 corresponds to client device 110 shown in FIGS. 1A and 1B.

Role analysis platform 220 includes one or more devices capable of receiving, generating, storing, processing, and/or providing information associated with analyzing skills of entities, as described elsewhere herein. For example, role analysis platform 220 may include a cloud server or a group of cloud servers. In some implementations, role analysis platform 220 may be designed to be modular such that certain software modules can be swapped in or out depending on a particular need. As such, role analysis platform 220 may be easily and/or quickly reconfigured for different uses. In some implementations, as shown, role analysis platform 220 may be hosted in cloud computing environment 230. Notably, while implementations described herein describe role analysis platform 220 as being hosted in cloud computing environment 230, in some implementations, role analysis platform 220 may not be cloud-based (i.e., may be implemented outside of a cloud computing environment) or may be partially cloud-based. In some implementations, role analysis platform 220 corresponds to role analysis platform 120 shown in FIGS. 1A and 1B.

Cloud computing environment 230 includes an environment that hosts role analysis platform 220. Cloud computing environment 230 may provide computation, software, data access, storage, etc. services that do not require end-user (e.g., client device 210) knowledge of a physical location and configuration of system(s) and/or device(s) that hosts role analysis platform 220. As shown, cloud computing environment 230 may include a group of computing resources 225 (referred to collectively as “computing resources 225” and individually as “computing resource 225”). In some implementations, cloud computing environment 230 corresponds to cloud computing environment 130 shown in FIGS. 1A and 1B.

Computing resource 225 includes one or more personal computers, workstation computers, server devices, or another type of computation and/or communication device. In some implementations, computing resource 225 may host role analysis platform 220. The cloud resources may include compute instances executing in computing resource 225, storage devices provided in computing resource 225, data transfer devices provided by computing resource 225, etc. In some implementations, computing resource 225 may communicate with other computing resources 225 via wired connections, wireless connections, or a combination of wired and wireless connections.

As further shown in FIG. 2, computing resource 225 includes a group of cloud resources, such as one or more applications (“APPs”) 225-1, one or more virtual machines (“VMs”) 225-2, one or more virtualized storages (“VSs”) 225-3, and/or one or more hypervisors (“HYPs”) 225-4.

Application 225-1 includes one or more software applications that may be provided to or accessed by client device 210. Application 225-1 may eliminate a need to install and execute the software applications on client device 210. For example, application 225-1 may include software associated with role analysis platform 220 and/or any other software capable of being provided via cloud computing environment 230. In some implementations, one application 225-1 may send/receive information to/from one or more other applications 225-1, via virtual machine 225-2. In some implementations, applications 225-1 may include a set of specialized applications for analyzing a matrix of information, analyzing a network of information, extracting information from a set of data sources, modifying the information, or the like, such as a web crawler tool (e.g., an R statistical software based package rvest), a data manipulation tool (e.g., R statistical software based packages, dplyr, stringy, tm, stringdist, etc.), a data visualization tool (e.g., R statistical software based packages, igraph, d3network, etc.), or the like. Although some implementations, described herein, are described in terms of particular tools or packages, such tools and packages are illustrative examples and other tools and packages may be used for some implementations described herein.

Virtual machine 225-2 includes a software implementation of a machine (e.g., a computer) that executes programs like a physical machine. Virtual machine 225-2 may be either a system virtual machine or a process virtual machine, depending upon use and degree of correspondence to any real machine by virtual machine 225-2. A system virtual machine may provide a complete system platform that supports execution of a complete operating system (“OS”). A process virtual machine may execute a single program, and may support a single process. In some implementations, virtual machine 225-2 may execute on behalf of a user (e.g., client device 210), and may manage infrastructure of cloud computing environment 230, such as data management, synchronization, or long-duration data transfers.

Virtualized storage 225-3 includes one or more storage systems and/or one or more devices that use virtualization techniques within the storage systems or devices of computing resource 225. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations. In some implementations, data may be stored in a structured or unstructured format, which may include semi-structured data, and processing may be applied to convert between a structured and unstructured format for utilization in computations. Unstructured data may include data obtained from, for example, public domain sources, such as data obtained from web crawling, data obtained from a social media profile, or the like. Structured data may include unstructured data converted to a structured format, enterprise data stored in a structured format by an enterprise computing system, or the like.

Hypervisor 225-4 may provide hardware virtualization techniques that allow multiple operating systems (e.g., “guest operating systems”) to execute concurrently on a host computer, such as computing resource 225. Hypervisor 225-4 may present a virtual operating platform to the guest operating systems, and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

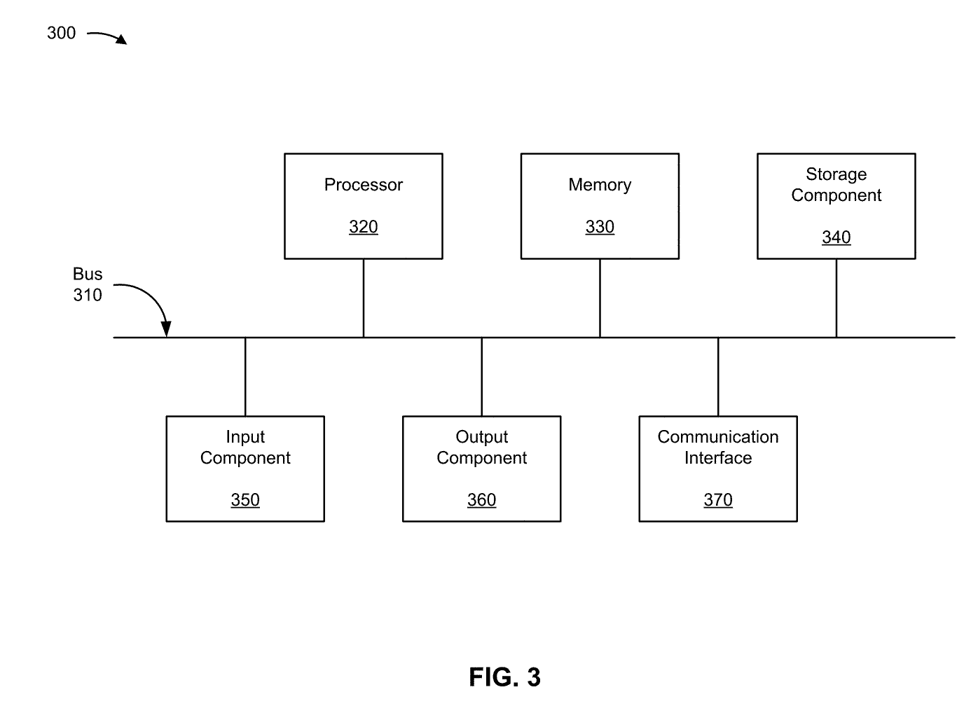

FIG. 3 is a diagram of example components of a device 300. Device 300 may correspond to client device 210 and/or role analysis platform 220. In some implementations, client device 210 and/or role analysis platform 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor, a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

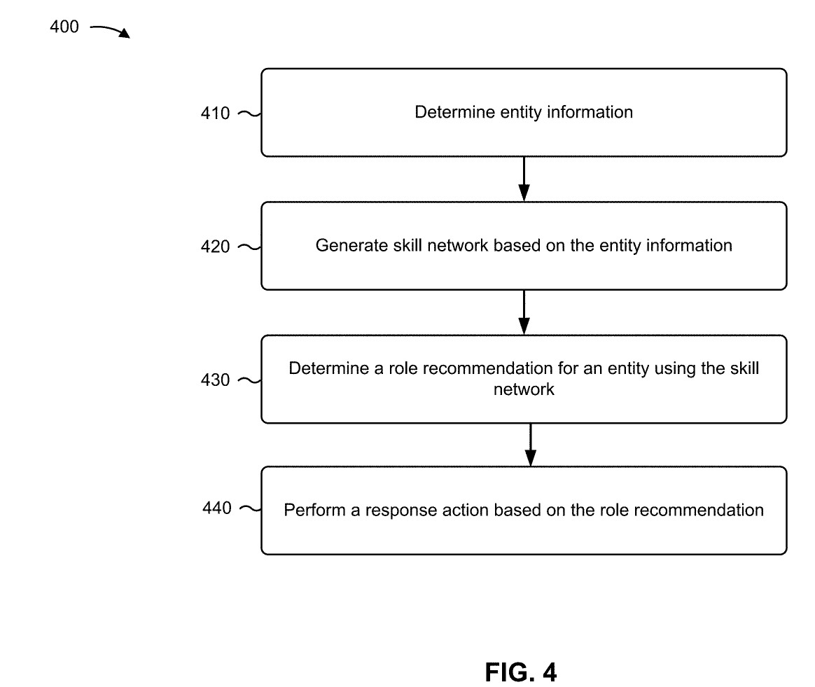

FIG. 4 is a flow chart of an example process 400 for determining a role recommendation using a skill network. In some implementations, one or more process blocks of FIG. 4 may be performed by role analysis platform 220. In some implementations, one or more process blocks of FIG. 4 may be performed by another device or a group of devices separate from or including role analysis platform 220, such as client device 210.

As shown in FIG. 4, process 400 may include determining entity information (block 410). For example, role analysis platform 220 may determine the entity information. In some implementations, role analysis platform 220 may perform a data extraction procedure to obtain entity data including the entity information. For example, role analysis platform 220 may access a set of enterprise-level data structures (e.g., enterprise system data structures of an organization), external data structures (e.g., data structures accessed via the Internet, such as social media data structures, communications channel data structures, or the like), internal data structures (e.g., data structures of role analysis platform 220, such as data structures including stored information associated with a previously performed analysis), or the like to obtain entity data.

In some implementations, role analysis platform 220 may obtain entity information using public application programming interfaces (APIs) and/or web crawling techniques (in accordance with relevant requirements of servers and/or data structures being accessed, such as data security requirements, anonymization requirements, terms and conditions, or the like). For example, role analysis platform 220 may identify a social media website associated with professional development, and may crawl the social media website to obtain resume-type information regarding a set of users of the social media website. In some implementations, role analysis platform 220 may utilize a text analytics or natural language processing technique to transform unstructured data into structured data for processing. For example, role analysis platform 220 may obtain natural language descriptions from the social media website, from a written resume, from a performance evaluation, or the like, and may perform natural language processing to extract information from a corpus of the natural language descriptions. In this case, role analysis platform 220 may extract information identifying a skill (e.g., a coding skill), a proficiency in a skill (e.g., a particular level of the coding skill of a set of levels), a job experience (e.g., a place of employment, a project completed, etc.), a salary level, a name, contact information, or the like.

In some implementations, role analysis platform 220 may obtain entity information regarding entities of the organization. For example, role analysis platform 220 may obtain hundreds, thousands, millions, or billions of data points regarding employees of an organization, such as data points identifying skills, roles, tasks performed, salary, performance reviews, or the like. Additionally, or alternatively, role analysis platform 220 may obtain entity information regarding entities of a similar organization to the organization. For example, role analysis platform 220 may determine a similarity score for one or more other organizations, such as based on an industry, a size (e.g., a quantity of employees, a market share, a revenue), a type (e.g., private, public, governmental, non-profit), a publically available list (e.g., a Fortune 500 list), or the like, and may select an organization from the one or more organizations with a threshold similarity score. Additionally, or alternatively, platform 220 may determine a similarity of the organization to one or more other organizations based on skills of employees of the one or more other organizations. In this case, role analysis platform 220 may obtain information regarding entities of the similar organization for use in analyzing the organization. In this way, role analysis platform 220 can utilize data regarding other organizations to permit role analysis platform 220 to generate a skill network for an organization with fewer than a threshold quantity of employees.

In some implementations, role analysis platform 220 may pre-process entity data obtained from one or more data sources. For example, role analysis platform 220 may pre-process the entity data to remove irregular data that may be incorrect. In this case, role analysis platform 220 may obtain entity data identifying a job experience as “110 years of experience”, may determine that the job experience is associated with a threshold difference from other applicants, and may determine that the job experience is erroneous (e.g., such as based on an intended “11 years of experience”) and can discard the job experience data, thereby reducing a likelihood that the erroneous data results in incorrect role recommendations. Additionally, or alternatively, role analysis platform 220 may utilize a machine learning technique to correct the erroneous data, such as by determining that a modification of the job experience to “11 years of experience” is associated with a threshold likelihood of being correct. In this way, role analysis platform 220 improves performance by ensuring that entities are not discarded from analysis based on a data error. In some implementations, role analysis platform 220 may structure the entity data using pre-processing into a user-item matrix format. For example, role analysis platform 220 may generate a skill relationship matrix identifying a set of “users” corresponding to a set of entities and a set of skills identified for each user (e.g., a first skill, such as a Java coding skill, a second skill, such as a C++ coding skill, etc.), thereby enabling analysis to be performed on the data.

In some implementations, role analysis platform 220 may utilize a term extraction technique to identify skills, such as in a corpus of text extracted from a social media profile. For example, role analysis platform 220 may remove a subset of words from an analysis of the text (e.g., a subset of words previously determined to be unrelated to skills, such as “the”, “and”, “is”, “a”, etc.), thereby reducing an amount of data that is to be analyzed to perform term extraction and reducing computing resource utilization relative to performing term extraction using every term in a corpus. Additionally, or alternatively, role analysis platform 220 may perform part of speech tagging of text and may remove non-informative tags (e.g., parts of speech previously determined not to be related to skills, such as pronouns, prepositions, etc.), thereby reducing a quantity of words in a corpus to reduce utilization of computing resources to perform term extraction. Additionally, or alternatively, role analysis platform 220 may perform lemmatization of terms in a corpus, thereby reducing inflectional forms of words and reducing use of computing resources associated with parsing each inflectional form of a common word separately to determine a meaning. Additionally, or alternatively, role analysis platform 220 may weight terms in a corpus based on a frequency, such as using an inverse document frequency technique (e.g., term frequency-inverse document frequency (tf-idf)).

In some implementations, role analysis platform 220 may extract a subset of words with a tf-idf value greater than a threshold, and may generate a skill proximity framework based on the subset of words. For example, role analysis platform 220 may generate a word embedding model (e.g., a dense, distributed representation of the subset of words) using a neural network technique. In this case, role analysis platform 220 may utilize a continuous bag of words (CBOW) technique, a skip gram technique, or the like to train and generate the word embedding model. In some implementations, role analysis platform 220 may generate apply dimensionality reduction techniques (e.g., t-distributed stochastic neighbor embedding (t-SNE)) on an output of a word embedding model to generate a representation of a position of each word in n-dimensional space (e.g., two-dimensional space, three-dimensional space, etc.), which may be utilized to determine and represent higher order relationships for sets of skills.

In this way, role analysis platform 220 obtains and pre-processes entity data to enable generation of a skill network for analysis and role recommendation generation.

As further shown in FIG. 4, process 400 may include generating a skill network based on the entity information (block 420). For example, role analysis platform 220 may generate the skill network based on the entity information. In some implementations, role analysis platform 220 may utilize a recommender technique (e.g., a recommendation problem based technique) to generate the skill network. For example, role analysis platform 220 may utilize an algorithm associated with generating a network of purchase relationships to generate a network of a set of skill relationships. In this case, the network of the set of skill relationships may be utilized to generate role recommendations based on prior skills and/or roles.

In some implementations, role analysis platform 220 may generate a skill relationship matrix that is to be transformed into a skill network. For example, role analysis platform 220 may determine a similarity between skills, such as using an item based collaborative filtering (IBCF) technique. Additionally, or alternatively, role analysis platform 220 may utilize a cosine similarity function technique to generate a similarity score (e.g., a cosine similarity score) between skills. In this case, role analysis platform 220 may determine a cosine similarity based on a cosine of an angle between two vectors (e.g., representing two skills, with each skill being characterized based on a user and a proficiency score for the user with respect to the skill) in n-dimensional vector space. In some implementations, based on determining similarities between skills, role analysis platform 220 may generate the skill relationship matrix representing a similarity score for each skill, of a set of skills, with regard to one or more other skills of the set of skills. In this case, role analysis platform 220 may transform the skill matrix into a network graph to generate the skill network. For example, role analysis platform 220 may generate a set of nodes representing the set of skills and a set of edges representing relationships between the set of skills (e.g., edge weights may represent first order similarity scores between nodes connected by corresponding edges).

In some implementations, role analysis platform 220 may determine skill similarity based on one or more higher order relationships for skills of a set of skills. For example, using a set of network analysis techniques, role analysis platform 220 may determine skill similarity scores based on a first order skill similarity and a higher order skill similarity. In some implementations, role analysis platform 220 may determine skill similarity using a shortest path algorithm technique. For example, role analysis platform 220 may determine a shortest path connecting a pair of skills in a network (e.g., a shortest path of edges connecting a set of nodes representing the pair of skills via a set of edges representing first order relationships between the set of skills). In this case, role analysis platform 220 may determine an aggregate similarity score between a pair of skills based on similarity scores for multiple pairs of skills of the skill network.

In some implementations, role analysis platform 220 may filter between multiple shortest paths based on comparing similarity indices (e.g., net similarity scores, average similarity scores, etc.) between different possible shortest paths.

As an example, for skill network with skill A connected to skill B (similarity score ab), skill B connected to skill C (similarity score bc), skill C connected to skill D (similarity score cd), skill D connected to skill E (similarity score de), and skill C connected to skill E (similarity score ce), role analysis platform 120 may determine a shortest path from skill A to skill E as ABCE and may determine a higher order similarity score as an average of ab, bc, ce. Additionally, or alternatively, for the same skill network, role analysis platform 120 may determine the similarity score as the greater of an average of ab, bc, ce and an average of ab, bc, cd, de. Additionally, or alternatively, role analysis platform 120 may determine the similarity score as an aggregate average of similarity scores based on ABCE and ABCDE. Such similarity score calculations are merely provided as examples and other similarity score calculations may be possible based on the skill network.

In some implementations, role analysis platform 220 may identify a set of critical nodes of the network, and may store information regarding the set of critical nodes. For example, role analysis platform 220 may utilize a critical node problem (CNP) technique to identify a subset of nodes (e.g., skills) of the skill network for which removal of the nodes results in a threshold fragmentation of the skill network.

In this way, role analysis platform 220 represents relationships between skills in a graph network format for utilization in determining higher order relationships between sets of skills, critical node skills, role recommendations, or the like.

As further shown in FIG. 4, process 400 may include determining a role recommendation for an entity using the skill network (block 430). For example, role analysis platform 220 may determine the role recommendation for the entity using the skill network. In some implementations, role analysis platform 220 may determine a role recommendation relating to matching a job requirement to a candidate profile. For example, role analysis platform 220 may determine that a particular job at the organization requires a first set of skills (e.g., “Java”, “HTML5”, and “Hadoop”) and that a candidate profile on a resume website indicates that a candidate possesses a second set of skills (e.g., “Java”, “CSS”, and “MongoDB”) that is at least partially different from the first set of skills. In this case, role analysis platform 220 may determine a direct match for a first skill (e.g., “Java” being in both the first set of skills and the second set of skills), a first order match for a second skill (e.g., “HTML5” and “CSS” being associated with a threshold similarity score), and a second order match for a third skill (e.g., a shortest path in a skill network of “Hadoop”-“NoSQL”-“MongoDB” resulting in a threshold similarity score). Based on the direct match, first order match, and second order match, role analysis platform 220 may determine to recommend the job for the candidate.

In some implementations, role analysis platform 220 may determine a recommendation score based on a set of similarity scores. For example, role analysis platform 220 may determine a 100% match for the first skill, a 21% match for the second skill, and a 15% match for the third skill, and may determine a recommendation score as an average of the similarity scores (e.g., 46%), and may recommend the candidate based on the recommendation score satisfying a threshold. Additionally, or alternatively, role analysis platform 220 may determine to recommend an entity for a role based on each similarity score, of the set of similarity scores, satisfying a threshold (e.g., being greater than 10%).

In some implementations, role analysis platform 220 may determine a role recommendation relating to training an entity for a role. For example, based on the critical node analysis identifying a subset of skills that are critical for connecting other skills (e.g., a subset of skills most likely to be included in a shortest path between pairs of skills), role analysis platform 220 may identify a set of employees of an organization for training in the subset of skills to ensure the organization maintains staffing for future projects requiring the subset of skills or skills with a threshold similarity score to the subset of skills.

In some implementations, role analysis platform 220 may determine a predicted proficiency growth for an employee based on the skill network. For example, based on an employee having a first skill with a threshold similarity to a second skill, role analysis platform 220 may determine an effectiveness score for training in the second skill, and may recommend the employee for a training program based on the effectiveness score. In some implementations, role analysis platform 220 may determine to select employees for training in one or more critical node skills for which employees of an organization lack a threshold level of proficiency. For example, role analysis platform 220 may identify a set of vulnerable nodes for which less than a threshold quantity of employees satisfy a threshold level of proficiency, and may select employees for training to obviate a risk that the organization is unable to fulfill a task associated with skills corresponding to the set of vulnerable nodes.

As further shown in FIG. 4, process 400 may include performing a response action based on the role recommendation (block 440). For example, role analysis platform 220 may perform the response action. In some implementations, role analysis platform 220 may communicate with one or more other devices to perform the response action. For example, role analysis platform 220 may communicate with a job website server to automatically set up a job interview for a candidate matching a particular role, to automatically notify a candidate that the candidate is hired for a particular role, or the like. Additionally, or alternatively, role analysis platform 220 may communicate with client device 210 to provide a calendar entry to a calendar application of client device 210 to set up a meeting for a set of hiring stakeholders to discuss potential job applicants identified by role analysis platform 220.

In some implementations, role analysis platform 220 may generate a user interface. For example, role analysis platform 220 may generate a user interface, for display via client device 210, identifying a set of critical node skills, the skill network, a set of role recommendations, a training program, or the like. In some implementations, role analysis platform 220 may obtain the training program. For example, role analysis platform 220 may search the Internet to identify a training program for a particular skill or for another skill with a threshold similarity, may obtain the training program, and may provide the training program to a selected entity via the user interface.

In some implementations, role analysis platform 220 may reassign employees to roles based on the role recommendation. For example, role analysis platform 220 may provide information identifying a more efficient allocation of employees to roles to reduce a utilization of computing resources to complete tasks associated with the roles, reduce errors associated with tasks to be completed in the roles, or the like relative to a previous assignment of roles.

In some implementations, role analysis platform 220 may provide information identifying a set of skill ratings to employees. For example, role analysis platform 220 may automatically book a conference room for an employee discussion (e.g., employee coaching, employee compensation determinations, or the like), and may provide a user interface for display via a client device 210 operating in the conference room to provide information identifying the set of skill ratings for discussion during the employee discussion. In some implementations, role analysis platform 220 may generate an organizational analysis based on skills of employees of the organization, and may provide information identifying results of the organizational analysis. For example, based on skills of employees at the organization and another analyzed organization, role analysis platform 220 may generate a recommendation relating to a merger with and/or acquisition of the other analyzed organization, and may provide the recommendation.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In this way, some implementations described herein may utilize a skill network to determine skill similarity and generate role recommendations based on skill similarity. Moreover, some implementations, described herein, may enable an organization to recruit job applicants based on job profiles listing skills of the job applicants with a greater degree of effectiveness relating to determining skill similarity with a greater degree of accuracy relative to other techniques. Furthermore, based on improving identifying of job applicants and/or assignment of employees to roles, some implementations described herein may reduce a utilization of computing resources, a utilization of network resources, a utilization of energy resources, or the like relative to other techniques for managing employees.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive data regarding a set of entities;
pre-process the data regarding the set of entities to convert a portion of the data from an unstructured format to a structured format;
generate, after pre-processing the data, a network representation of the data,
the network representation including a plurality of nodes representing characteristics of the data and a plurality of edges connecting at least some of the plurality of nodes and representing a relationship between each pair of connected nodes of the plurality of nodes;
automatically evaluate the network representation of the data to determine a set of recommendations relating to the set of entities;
generate a user interface to provide information identifying the set of recommendations; and
communicate with a client device to cause the user interface to be provided for display via the client device.

2. The device of claim 1, where the one or more processors are further to:
determine a set of first order relationships between each pair of connected nodes of the plurality of nodes,
a first order relationship, of the set of first order relationships, relating to a similarity of a first characteristic corresponding to a first node, of the plurality of nodes, to a second characteristic corresponding to a second node of the plurality of nodes; and
generate the plurality of edges based on the set of first order relationships,
the first node being connected to the second node by an edge, of the plurality of edges, associated with an edge weight relating to the first order relationship.

3. The device of claim 1, where the one or more processors are further to:
determine a second order relationship between a first characteristic corresponding to a first node and a second characteristic corresponding to a second node,
the second order relationship being based on a plurality of first order relationships corresponding to a shortest path between the first node and the second node in the network representation of the data.

4. The device of claim 3, where the shortest path corresponds to at least one of:
a largest aggregate edge weight of edges connecting the first node to the second node, or
a shortest quantity of edges connecting the first node to the second node.

5. The device of claim 1, where the set of entities are a set of job applicants and the characteristics are a set of skills; and
where the one or more processors, when automatically evaluating the network representation of the data to determine the set of recommendations, are to:
automatically evaluate the network representation to determine a particular recommendation, of the set of recommendations, relating to identifying a particular job applicant associated with a first one or more skills, of the set of skills, satisfying a threshold similarity to a second one or more skills for a particular job.

6. The device of claim 1, where the one or more processors are further to:
provide information identifying the network representation of the data for display in the user interface.

7. The device of claim 1, where the one or more processors are further to:
crawl a wide area network to obtain one or more natural language corpuses relating to the set of entities; and
perform a natural language processing technique on the one or more natural language corpuses to determine the data regarding the set of entities.

8. A method, comprising:
determining, by a device, entity information regarding a set of entities,
the set of entities including at least one of a set of potential job applicants to an organization or a set of employees of the organization;
generating, by the device, a skill network representing a set of first order relationships and a set of higher order relationships between pairs of skills of a set of skills;
determining, by the device, a role recommendation for one or more entities of the set of entities,
the role recommendation identifying a recommended role for the one or more entities,
the recommended role being a new role or a change to a role for the one or more entities; and
performing, by the device, a response action based on the role recommendation.

9. The method of claim 8, where generating the skill network comprises:
processing the entity information using a recommender technique to determine a subset of skills, of the set of skills, satisfying a threshold similarity to a particular skill of the set of skills.

10. The method of claim 8, where generating the skill network comprises:
processing the entity information using an item based collaborative filtering technique to determine a similarity score for the pairs of skills.

11. The method of claim 10, where the similarity score is a cosine similarity score relating to vectors associated with the pairs of skills.

12. The method of claim 8, further comprising:
identifying a set of critical nodes of the skill network relating to a subset of skills of the set of skills; and
where performing the response action comprises:
transmitting a message to a client device associated with a particular potential job applicant of the set of potential job applicants,
the message being related to hiring the particular potential job applicant,
the particular potential job applicant being associated with a threshold level of proficiency in one or more skills of the subset of skills.

13. The method of claim 8, where performing the response action comprises:
communicating with another device to provide information identifying at least one of:
a message,
a calendar appointment, or
a user interface.

14. The method of claim 8, where performing the response action comprises:
identifying a training program for the one or more entities;
obtaining the training program; and
providing the training program for display via one or more client devices associated with the one or more entities.

15. The method of claim 8, where determining the role recommendation comprises:
determining a recommendation of an entity, of the one or more entities, for a role of the organization,
the role being associated with a first subset of the set of skills,
the entity being associated with a threshold level of proficiency for a second subset of the set of skills,
at least one skill of the second subset not being included in the first subset and having a threshold similarity to a corresponding at least one of the first sub set.

16. A non-transitory computer-readable medium storing instructions, the instructions comprising:
one or more instructions that, when executed by one or more processors, cause the one or more processors to:
obtain entity information regarding a set of entities from a set of data sources,
the set of entities including at least one of a set of potential job applicants to an organization or a set of employees of the organization;
generate a skill network representing a set of first order relationships and a set of higher order relationships between pairs of skills of a set of skills,
the skill network including a set of nodes representing the set of skills and a set of edges representing the first order relationships between skills of the set of skills;
determine a role recommendation,
the role recommendation identifying a role for an entity of the set of entities,
the entity being associated with a first subset of skills,
the role being associated with a second subset of skills including at least one skill not included in the first subset of skills,
the at least one skill having a threshold similarity to a corresponding at least one skill of the first subset of skills; and
provide information associated with identifying the role recommendation.

17. The non-transitory computer-readable medium of claim 16, where the at least one skill of the second subset of skills is associated with a higher order relationship to the corresponding at least one skill of the first subset of skills,
the higher order relationship being determined based on a shortest path between a first node, of the set of nodes, corresponding to the at least one skill of the second subset of skills and a second node, of the set of nodes, corresponding to the at least one skill of the first subset of skills.

18. The non-transitory computer-readable medium of claim 16, where the one or more instructions, when executed by the one or more processors, further cause the one or more processors to:
provide information identifying the set of higher order relationships.

19. The non-transitory computer-readable medium of claim 16, where the one or more instructions, that cause the one or more processors to obtain the entity information, cause the one or more processors to:
obtain the entity information from at least one of:
a data source of an enterprise-level data,
a data source of an external entity data, or
a data source of an internal entity data.

20. The non-transitory computer-readable medium of claim 16, where the one or more instructions, when executed by the one or more processors, cause the one or more processors to:
determine a vulnerable node of the set of nodes,
the vulnerable node corresponding to a skill, of the set of skills, with less than a threshold quantity of entities being associated with a threshold level of proficiency in the skill or another skill with a threshold similarity to the skill; and
provide information identifying the vulnerable node.
